(19) United States
(12) Patent Application Publication
(10) Pub. No.: US 2021/0323134 A1
(43) Pub. Date: Oct. 21, 2021

(54) Hammer With Improved Striking Face

(71) Applicant: APEX BRANDS, INC., Apex, NC (US)

(72) Inventors: Nicholas Ryan Imsand, Huntersville, NC (US); Ian Cunningham, Charlotte, NC (US)

(21) Appl. No.: 17/232,316

(22) Filed: Apr. 16, 2021

Related U.S. Application Data
(60) Provisional application No. 63/013,212, filed on Apr. 21, 2020.

(51) Int. Cl. B25D 1/02

(52) U.S. Cl. CPC B25D 1/02; B25D 1/04

(57) ABSTRACT

A hand tool may include a head having a bell and a face for delivering an impact at a front end of the head. The hand tool may also include a handle operably coupled to the head and extending linearly away from the head along an axis. The bell may be perimeter weighted such that a void space is disposed within the bell rearward of the face and spaced apart from peripheral edges of the bell and the face.

### TECHNICAL FIELD

Example embodiments generally relate to hand tools and, in particular, relate to a hammer that is structured to provide improved accuracy.

### BACKGROUND

Hand tools are commonly used across all aspects of industry and in the homes of consumers. Hand tools are employed for multiple applications including, for example, tightening, component joining, and/or the like. For some joining applications, a hammer, and particularly a hammer and nails, may be used. However, hammers are used in many other contexts as well, and are a tool that has been in use by humans for many thousands of years.

The history of hammers, like so many other tools, is a tale of continuous improvement as better materials and ways of employing those materials have advanced. From stone hammer heads with bone or wooden handles, to the replacement of the stone with stronger and stronger metals, hammers evolved significantly. Later, to improve durability, the entire hammer (i.e., the head and the handle, began to be made from metallic materials. However, in spite of the great improvement in durability, the weight of such devices and the cost in terms of relatively expensive metallic materials demanded yet further improvement.

Modern hammers are often made with combinations of materials that are meant to balance the cost and durability. However, even these modern hammers can suffer from rigid design criteria that limit performance in certain respects. For example, the somewhat monolithic design feature of having a solid mass that forms the bell, which supports the striking face of the hammer, may cause the “sweet spot” of the hammer head to actually be fairly small. In particular, the conventional striking face tends to isolate all of the force of a hammer strike onto a relatively small portion of the face, near its center. This small sweet spot means that any strikes that occur away from the center of the striking face can lead to bending, or even ejecting, of nails from the striking surface. Accordingly, it may be desirable to consider alternative design options that may improve the accuracy of the hammer when striking nails or other objects.

### BRIEF SUMMARY OF SOME EXAMPLES

In an example embodiment, a hand tool may be provided. The hand tool may include a head having a bell and a face for delivering an impact at a front end of the head. The hand tool may also include a handle operably coupled to the head and extending linearly away from the head along an axis. The bell may be perimeter weighted such that a void space is disposed within the bell rearward of the face and spaced apart from peripheral edges of the bell and the face.

In another example embodiment, a bell for supporting a striking face for an impact hand tool may be provided. The bell may include a stem portion extending rearward from a center of the bell behind the striking face toward a throat operably coupling a head of the hammer to the bell. The bell may further include a peripheral wall spaced apart from the stem portion by a void space disposed therebetween. The peripheral wall may provide perimeter weighting for the striking face.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a hammer or similar impact delivering hand tool according to an example embodiment;

FIG. 2 is a front view of the hammer of FIG. 1 in accordance with an example embodiment;

FIG. 3 is top view of the hammer of FIG. 1 in accordance with an example embodiment;

FIG. 4 a partial cross section view of a bell of the hammer in accordance with an example embodiment;

FIG. 5 a partial cross section view of a removable and replaceable bell of the hammer in accordance with an example embodiment

FIG. 6 a partial cross section view of another removable and replaceable bell of the hammer in accordance with an example embodiment; and

FIG. 7 illustrates a cross section view of the bell of the hammer of FIG. 3 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a hand tool (e.g., a hammer) with an improved design that provides for improved accuracy of the striking face. In this regard, for example, the bell (or poll) of the hammer may be configured to have perimeter weighting. By perimeter weighting the bell, outer peripheral edges of the striking face may have more weight behind them in order to provide improved power transfer with less effort. The perimeter weighting may also improve accuracy of the striking face for more forgiving mis-hits (i.e., a larger sweet spot) and less nail bending. These improvements may also reduce fatigue for operators of the hammer and reduce the chance of mishaps relating to inaccurate striks.

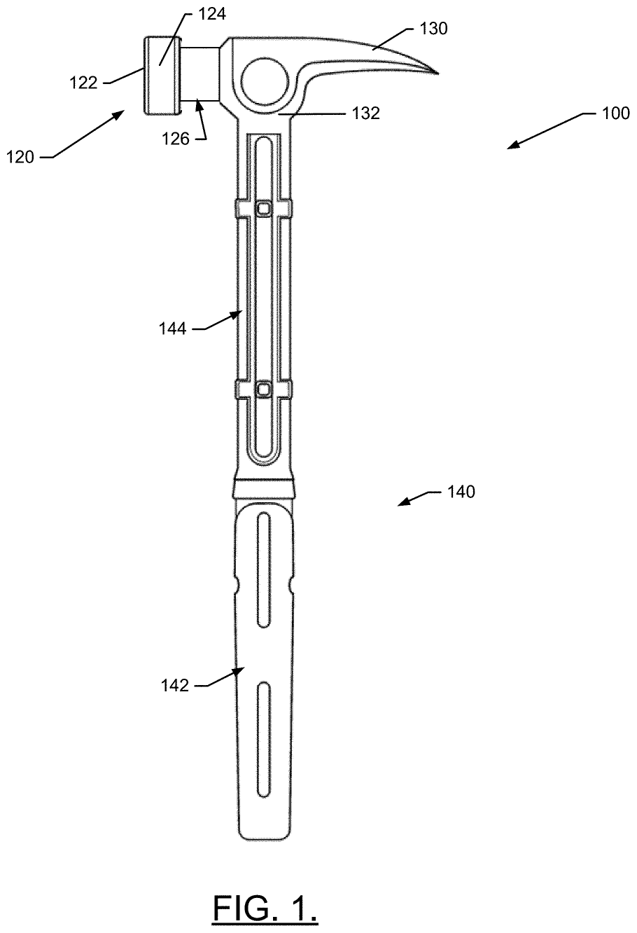

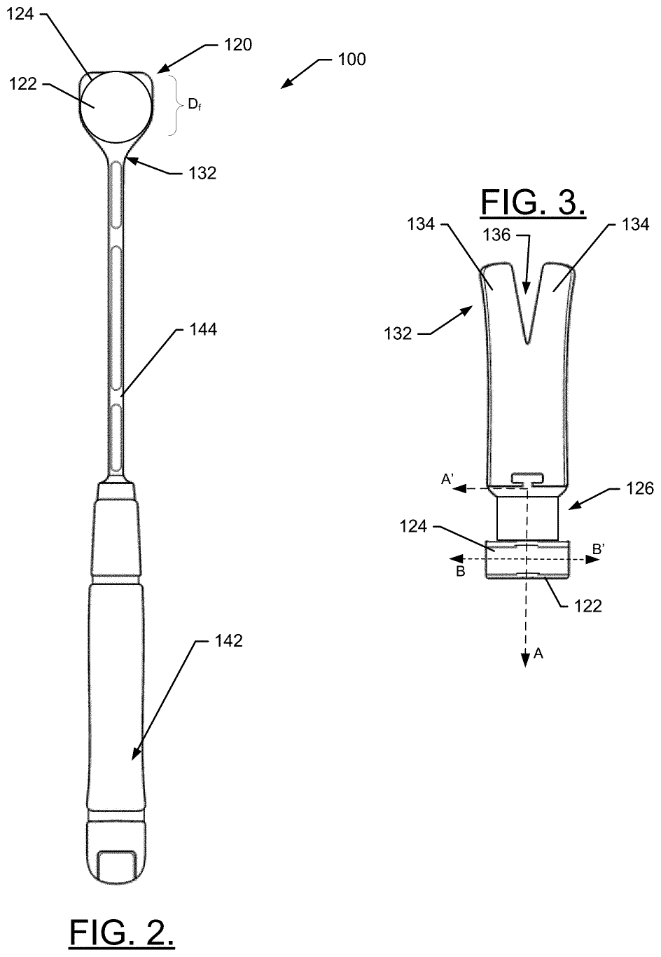

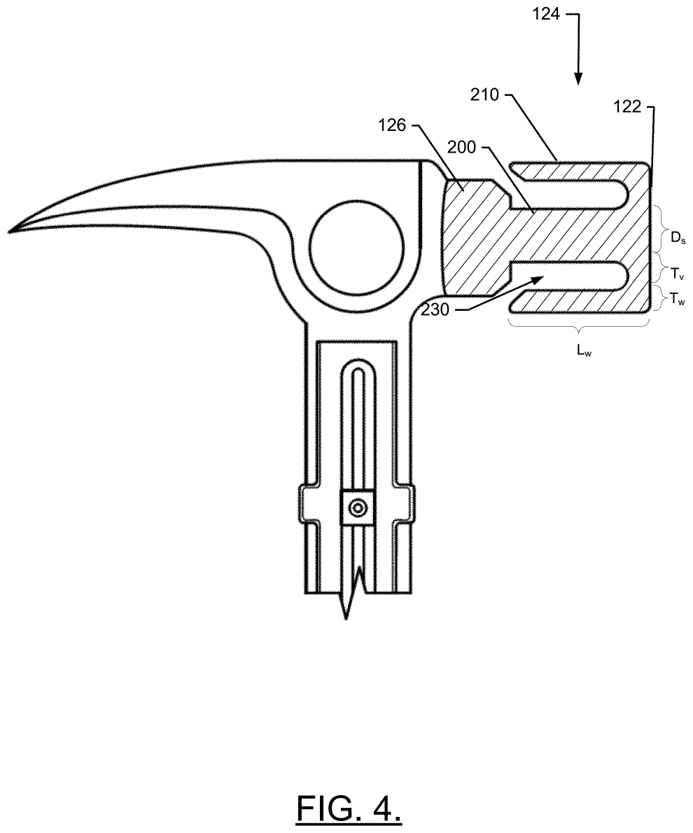

FIGS. 1-3 illustrate various views of a hammer 100 according to an example embodiment. In this regard, FIG. 1 illustrates a side view of the hammer 100, while FIGS. 2 and 3 show the hammer 100 from the front and top, respectively. FIGS. 4-6 show partial cross section views through a part of a head 120 of the hammer 100 that has been modified as described herein for improved accuracy.

Referring first to FIGS. 1-3, a metallic base structure may be cast or forged as a single unitary piece to form the base part of the hammer 100. Other parts may then be added on to the metallic base structure as described herein. The hammer 100 may include a head 120 and a handle 140. The head 120 may include a number of parts such as, for example, a face 122, which forms the striking surface of the hammer 100, and which is disposed at a distal end of a bell 124 of the head 120. The bell 124 may be attached to remaining portions of the head 120 by a throat 126 (sometimes referred to as a neck), which is tapered somewhat or otherwise has a smaller diameter than the bell 124.

Opposite the face 122, the head 120 may further include a claw 130. The bell 124 may be separated from the claw 130 by an eye portion 132. The lateral side of the head 120 (i.e., between the claw 130 and the bell 124, and above the eye portion 132) may be referred to as a cheek. The eye portion 132 may correspond to the eye that typically received the handle when the handle was made of a separate component or material from the head 120. However, as noted above, in this case the hammer 100 (or at least a base portion thereof) is formed from a single unitary piece so the eye portion 132 simply correlates to the location of the eye on a conventional multi-piece hammer, but does not necessarily function as such. Instead, the eye portion 132 therefore represents a point at which the handle 140 intersects with the head 120.

The claw 130 may include two laterally extending claw members 134 having a nail slot 136 formed therebetween. The head of a nail can be placed in the nail slot 136 and the claw members 134 may engage the head such that when the hammer 100 is pivoted about the eye portion 132, leverage is placed on the nail to remove the nail from the medium into which it had been driven. The claw 130 may have other uses as well, often related to prying. It should also be appreciated that the claw 130 may be replaced by a peen in some cases, and thus the particular design of the head 120 may be different in some cases without impacting other aspects of example embodiments.

The handle 140 may include a grip portion 142 and a beam portion (or beam 144). The beam 144 may extend from the eye portion 132 (at a proximal end of the beam 144) to the grip portion 142 (at a distal end of the beam 144). Thus, a proximal end of the grip portion 142 may be attached to a distal end of the beam 144, and a distal end of the grip portion 142 may extend away from the eye portion 132 and the beam 144 in alignment with the beam 144. The grip portion 142 and the beam 144 may therefore have a longitudinal centerline (or axis) that is common and extends away from the eye portion 132.

As discussed above, the head 120 may be designed for improved accuracy of the striking face (i.e., face 122). Providing such increased accuracy may be a function of perimeter weighting the bell 124. Some examples of perimeter weighting of the bell 124 are shown in FIGS. 4-6, which illustrate partial cross section views of the bell 124, the face 122 and the neck 126, taken along the lines A-A′ in FIG. 3. Meanwhile, FIG. 7 illustrates a cross section view of the bell 124 taken along line B-B′ in FIG. 3.

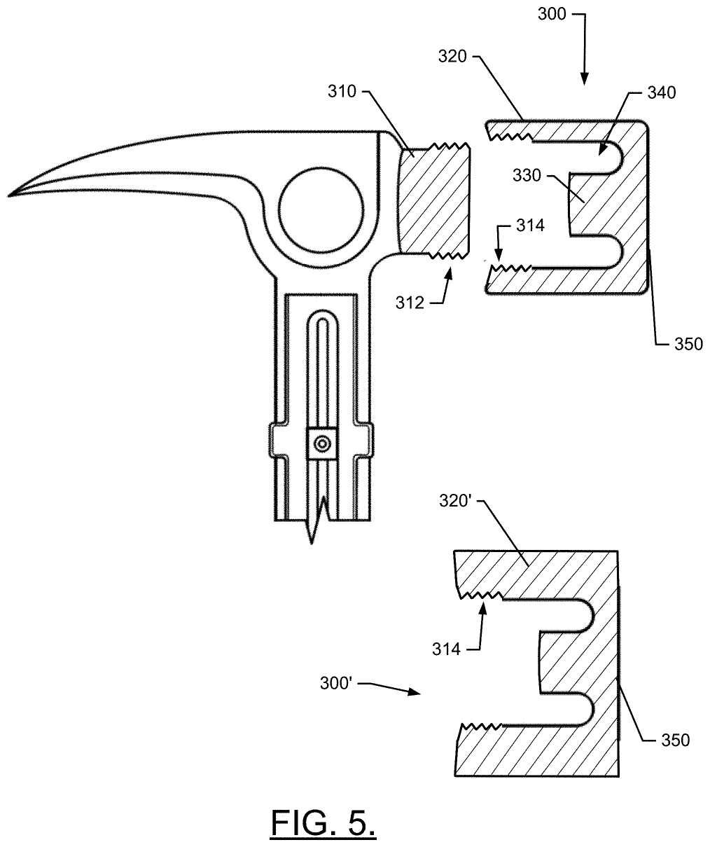

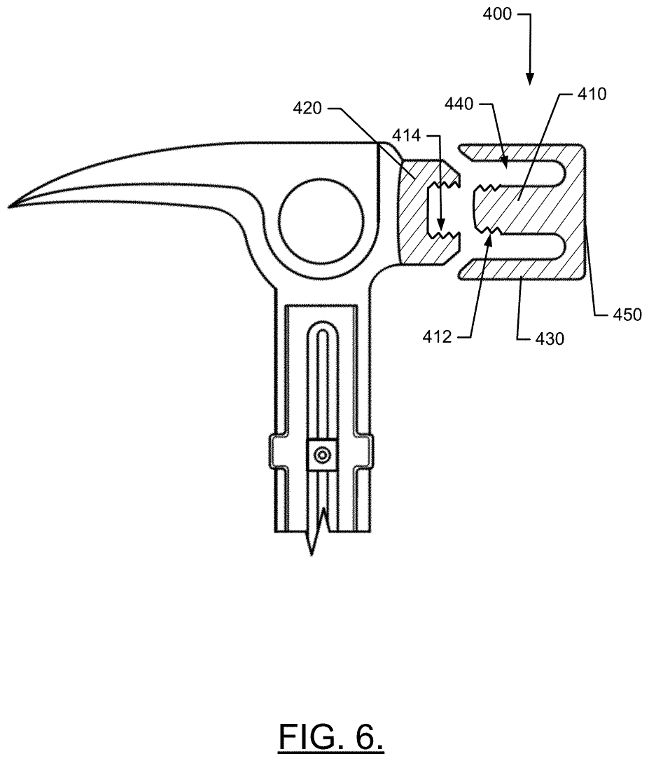

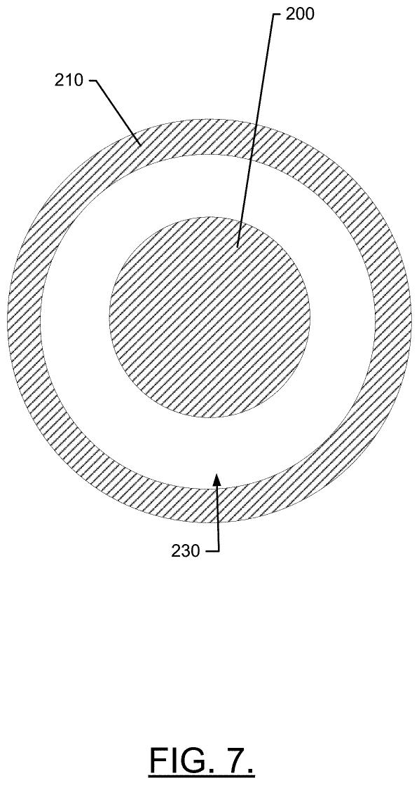

Referring first to the example of FIG. 4, the bell 124 may be constructed to include a stem portion 200 and a peripheral wall 210. A void space 230 may therefore be provided between the stem portion 200 and the peripheral wall 210 in order to provide the perimeter weighting of the bell 124. The stem portion 200 may be an extension of the throat 126. As such, the throat and the stem portion 200 could have the same diameter. However, in the example shown in FIG. 4, the stem portion 200 has a diameter (Dₛ) that is less than a diameter of the throat 126. Meanwhile the diameter (Dₛ) of the stem portion 200 is less than half a diameter (D_{f}) of the face 122. The stem portion 200 may provide support for the bell 124 and, in some cases, may be the only connection point between the bell 124 and the throat 126. However, as shown in FIGS. 5 and 6, the peripheral wall 210 may also support the bell 124 (partially or exclusively) in some examples.

A thickness (T_{w}) of the peripheral wall 210 may contribute to the amount of weight that is distributed to the perimeter of the face 122. A length (L_{w}) of the peripheral wall 210 also contributes to the amount of weight that is distributed to the perimeter of the face 122. In some cases, the length (L_{w}) of the peripheral wall 210 may be about equal to a length of the stem portion 200. However, the length (L_{w}) of the peripheral wall 210 could be shorter or longer than the stem portion 200 in other examples.

In the example of FIG. 4, since the length (L_{w}) of the peripheral wall 210 is about equal to the length of the stem portion 200, a length of the void space 230 may also be about equal to the length (L_{w}) of the peripheral wall 210. A thickness (Tᵥ) or width of the void space 230 may be slightly larger than a thickness (T_{w}) of the peripheral wall 210. However, other ranges (including larger or smaller) for the thickness (Tᵥ) of the void space 230 and the thickness (T_{w}) of the peripheral wall 210 may be employed in various alternative embodiments in order to achieve the desired performance characteristics and physical traits for the hammer 100.

In this regard, for example, the stem portion 200 may be made thinner and/or the peripheral wall 210 may be made thicker (and/or longer) in order to move more weight to the perimeter of the face 122. In some cases, different versions of the hammer 100 could be cast or forged with corresponding different characteristics in order to provide different perimeter weights and therefore different striking characteristics. However, rather than making specific tools for corresponding specific different uses, it may also be possible to make the hammer 100 itself adjustable. In this regard, for example, the bell 124 may be removable and/or replaceable so that different bell attachments can be selected for corresponding different uses or environments. FIGS. 5 and 6 illustrate examples of different structural designs that may facilitate changing bell attachments in accordance with different example embodiments.

FIG. 5 illustrates an example in which a bell attachment 300 is configured to be attached (or removed) from the throat 310 via a first thread assembly 312 formed on an outer periphery of the throat 310, and a second thread assembly 314 formed on an inner periphery of a proximal end of a peripheral wall 320. Stem portion 330 may be formed at a center region of the bell attachment 300 and the stem portion 330 may abut against the throat 310 when attached (i.e., when the first and second thread assemblies 312 and 314 are fully engaged with each other or tightened). However, in some cases, a gap may be formed between the stem portion 330 and the throat 310 even when the first and second thread assemblies 312 and 314 are fully engaged. In any case, a void space 340 is still formed between the stem portion 330 and the peripheral wall 320 to provide for perimeter weighting of face 350. As such, the void space 340 is disposed behind a portion of the face 350 to distribute more weight toward the perimeter of the face 350.

The bell attachment 300 may have a specific weight (e.g., 16 ounces) that is tailored to a particular context or use (e.g., finishing). Meanwhile, larger and/or heavier attachments can be used for other contexts or uses. For example, bell attachment 300′ may share the same interface characteristics as the bell attachment 300 (i.e., having the same second thread assembly 314 and inner diameter for the peripheral wall 320′). However, the bell attachment 300′ may have thicker and heavier walls for the peripheral wall 320′ so that the bell attachment 300′ may have an overall heavier weight for a different use (e.g., 20 ounces for general purpose usage or 24 ounces for framing).

As an alternative (or in addition) to putting threads on the peripheral walls of the bell, the throat and stem portion could be removably connected to each other. FIG. 6 illustrates one such example. In this regard, in the example of FIG. 6, bell attachment 400 includes stem portion 410 with a first thread assembly 412 on an external periphery of the stem portion 410. A second thread assembly 414 is disposed in throat 420 to interface with the first thread assembly 412. Peripheral wall 430 is spaced apart from the stem portion 410 to form a void space 440 behind at least a portion of the face 450.

Accordingly, as can be appreciated from the examples of FIGS. 4-6, the bell 124 could be fixed or removable. Moreover, for removable bells (300, 300′ and 400) male and female portions of the interface between the removable bell and the head 120 may be on either side of the interface. In any case, the perimeter weighting strategy can be implemented to improve strike accuracy. As can be appreciated from FIG. 7, the void space 230 may generally have an annular shape with an axis of the annulus being substantially perpendicular to an axis of the handle 140.

A hand tool (e.g., a hammer) of an example embodiment may include a head. The head may include a bell and a face for delivering an impact at a front end of the head. The hand tool may also include a handle operably coupled to the head and extending linearly away from the head along an axis. The bell may be perimeter weighted such that a void space is disposed within the bell rearward of the face and spaced apart from peripheral edges of the bell and the face.

The hand tool (or simply the bell thereof) may include a number of modifications, augmentations, or optional additions, some of which are described herein. The modifications, augmentations or optional additions may be added in any desirable combination. For example, the void space may be annular shaped, and an axis of the annular shaped void space may be substantially perpendicular to an axis of the handle. In an example embodiment, the head may include a throat operably coupling the bell to the head. The bell may include a stem portion extending rearward from a center of the bell behind the face toward the throat. The void space may be disposed between the peripheral edge of the bell and the stem portion. In some cases, a peripheral wall may form the peripheral edge of the bell. In an example embodiment, the bell may be removable and replaceable by another bell having a different weight than the bell. In some cases, the bell may be removable and replaceable via operation of a first thread assembly on the stem portion and a second thread assembly on the throat. In an example embodiment, the bell may be removable and replaceable via operation of a first thread assembly on the peripheral wall and a second thread assembly on the throat. In some cases, a thickness of the peripheral wall may be different between the bell and the other bell. In an example embodiment, a thickness of the void space may be larger than a thickness of the peripheral wall. In some cases, a thickness of the void space may be smaller than a thickness of the peripheral wall. In an example embodiment, a diameter of the throat may be larger than a diameter of the stem portion. In some cases, a diameter of the stem portion may be less than half a diameter of the face. In an example embodiment, a gap may be disposed between the stem portion and the throat.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head having a bell and a face for delivering an impact at a front end of the head; and
a handle operably coupled to the head and extending linearly away from the head along an axis,
wherein the bell is perimeter weighted such that a void space is disposed within the bell rearward of the face and spaced apart from peripheral edges of the bell and the face.

2. The hand tool of claim 1, wherein the void space is annular shaped, and
wherein an axis of the annular shaped void space is substantially perpendicular to an axis of the handle.

3. The hand tool of claim 1, wherein the head comprises a throat operably coupling the bell to the head,
wherein the bell comprises a stem portion extending rearward from a center of the bell behind the face toward the throat, and
wherein the void space is disposed between the peripheral edge of the bell and the stem portion.

4. The hand tool of claim 3, wherein a peripheral wall forms the peripheral edge of the bell.

5. The hand tool of claim 4, wherein the bell is removable and replaceable by another bell having a different weight than the bell.

6. The hand tool of claim 5, wherein the bell is removable and replaceable via operation of a first thread assembly on the stem portion and a second thread assembly on the throat.

7. The hand tool of claim 5, wherein the bell is removable and replaceable via operation of a first thread assembly on the peripheral wall and a second thread assembly on the throat.

8. The hand tool of claim 5, wherein a thickness of the peripheral wall is different between the bell and the other bell.

9. The hand tool of claim 4, wherein a thickness of the void space is larger than a thickness of the peripheral wall.

10. The hand tool of claim 4, wherein a thickness of the void space is smaller than a thickness of the peripheral wall.

11. The hand tool of claim 3, wherein a diameter of the throat is larger than a diameter of the stem portion.

12. The hand tool of claim 3, wherein a diameter of the stem portion is less than half a diameter of the face.

13. The hand tool of claim 3, wherein a gap is disposed between the stem portion and the throat.

14. A bell supporting a striking face for an impact hand tool, the bell comprising:
a stem portion extending rearward from a center of the bell behind the striking face toward a throat operably coupling a head of the hammer to the bell; and
a peripheral wall spaced apart from the stem portion by a void space disposed therebetween,
wherein the peripheral wall provides perimeter weighting for the striking face.

15. The bell of claim 14, wherein the void space is annular shaped, and
wherein an axis of the annular shaped void space is substantially perpendicular to an axis of a handle of the hand tool.

16. The bell of claim 14, wherein the bell is removable and replaceable by another bell having a different weight than the bell.

17. The bell of claim 16, wherein the bell is removable and replaceable via operation of a first thread assembly on the stem portion and a second thread assembly on the throat.

18. The bell of claim 16, wherein the bell is removable and replaceable via operation of a first thread assembly on the peripheral wall and a second thread assembly on the throat.

19. The bell of claim 16, wherein a thickness of the peripheral wall is different between the bell and the other bell.

20. The bell of claim 16, wherein a thickness of the void space is larger than a thickness of the peripheral wall,
wherein a diameter of the throat is larger than a diameter of the stem portion, and
wherein a diameter of the stem portion is less than half a diameter of the striking face.
